(19) United States
(12) Patent Application Publication
(10) Pub. No.: US 2013/0257367 A1
(43) Pub. Date: Oct. 3, 2013

(54) CONTACTLESS CHARGING SYSTEM AND CHARGING DEVICE

(71) Applicant: CASIO COMPUTER CO., LTD., Tokyo (JP)

(72) Inventor: Kaoru SOMEYA, Tokyo (JP)

(73) Assignee: CASIO COMPUTER CO., LTD., Tokyo (JP)

(21) Appl. No.: 13/845,029

(22) Filed: Mar. 17, 2013

(30) Foreign Application Priority Data
Mar. 28, 2012 (JP) 2012-073445

(51) Int. Cl. H02J 7/02

(52) U.S. Cl. CPC H02J 7/025
USPC 320/108

(57) ABSTRACT

A contactless charging system includes an electronic device and a charging device which includes an electricity transmission wire. The wire is disposed within a predetermined plane in a predetermined pattern by which directions of magnetic fields respectively generated in a first region and a second region into which an area where a ring-shaped frame of a case of the electronic device is disposed is divided are opposite to each other. The charging device applies an alternating current voltage having a predetermined frequency to the wire so as to generate the magnetic fields which change at the frequency, and charges an electricity accumulation unit of the electronic device disposed on the plane of the charging device by electromagnetic induction between an electricity reception coil of the electronic device and the wire.

### CROSS REFERENCE TO RELATED APPLICATION

This application is based upon and claims the benefit of priority under 35 USC 119 of Japanese Patent Application No. 2012073445 filed on Mar. 28, 2012, the entire disclosure of which, including the description, claims, drawings, and abstract, is incorporated herein by reference in its entirety.

### BACKGROUND OF THE INVENTION

1. Field of the Invention

The present invention relates to a contactless charging system and a charging device.

2. Description of the Related Art

Conventionally, there is a wireless charging device which can charge a battery without connection with an electronic device which has the battery by using a cable or a contact point or insertion of a replacement battery into the electronic device.

In general, there is a technology used in the wireless charging device, the technology to apply an alternating current (AC) voltage to a coil of a charger so as to generate change of magnetic flux in a coil of an electronic device to be charged, and to supply a coil current to a rechargeable battery of the electronic device on the basis of electromotive force generated by electromagnetic induction.

With respect to the technology using such a charging system, in Japanese Patent Application Laid-Open Publication No. 2003-185769, there is disclosed an electronic watch which selectively receives time information and power from an external device by using both functions to perform information communications and to perform power supply in accordance with temporal change of magnetic fields.

In the charging system by electromagnetic induction, if an electrically conductive layer exists between a coil of a charger and a coil of an electronic device to be charged, namely, for example, if a metallic back cover is used in the electronic device, heat is generated by an eddy current generated in the electrically conductive layer in accordance with the change of the magnetic flux penetrating the electrically conductive layer.

Then, in Japanese Patent Application Laid-Open Publication. No. 2009-164279, there is disclosed a technology to prevent generation of an eddy current by using a material having low electrical conductivity for the whole or a part of a back cover of an electronic device.

However, in a case where it is required to use a frame structure made of an electrically conductive material in an electronic device, when the electronic device is charged in a contactless manner, and the magnetic flux is outputted from a charging device in such a way as to penetrate a ring-shaped frame, the frame functions as a short circuit ring. Consequently, charging efficiency decreases, and the electronic device cannot be efficiently charged.

That is, there is a problem that an electronic device cannot be efficiently charged depending on a material of a frame structure thereof.

### BRIEF SUMMARY OF THE INVENTION

Objects of the present invention include providing a contactless charging system which can efficiently charge an electronic device with a simple configuration regardless of a material of a case of the electronic device.

According to a first aspect of the present invention, there is provided a contactless charging system including: an electronic device including: a case including a ring-shaped frame; an electricity reception coil disposed in the case; and an electricity accumulation unit connected to the electricity reception coil; and a charging device including: an electricity transmission wire disposed within a predetermined plane in a predetermined pattern by which directions of magnetic fields respectively generated in a first region and a second region into which an area where the frame is disposed is divided are opposite to each other, wherein the charging device applies an alternating current voltage having a predetermined frequency to the electricity transmission wire so as to generate the magnetic fields which change at the frequency, and charges the electricity accumulation unit of the electronic device disposed on the plane of the charging device by electromagnetic induction between the electricity reception coil and the electricity transmission wire.

According to a second aspect of the present invention, there is provided a charging device which charges an electronic device in a contactless manner, the electronic device including a case including a ring-shaped frame, an electricity reception coil disposed in the case and an electricity accumulation unit connected to the electricity reception coil, the charging device including: an electricity transmission wire disposed within a predetermined plane in a predetermined pattern by which directions of magnetic fields respectively generated in a first region and a second region into which an area where the frame is disposed is divided are opposite to each other, wherein the charging device applies an alternating current voltage having a predetermined frequency to the electricity transmission wire so as to generate the magnetic fields which change at the frequency, and charges the electricity accumulation unit of the electronic device disposed on the plane of the charging device by electromagnetic induction between the electricity reception coil and the electricity transmission wire.

### BRIEF DESCRIPTION OF THE SEVERAL VIEWS OF THE DRAWING

FIG. 1 shows an overall configuration of a contactless charging system in accordance with embodiments of the present invention.

FIGS. 2A and 2B each show shapes of an electricity transmission wire and an electricity reception coil and disposition thereof as an example.

FIGS. 3A and 3B each show shapes of the electricity transmission wire and the electricity reception coil and disposition thereof as an example.

FIGS. 4A and 4B each show patterns to dispose the electricity transmission wire as an example.

### DETAILED DESCRIPTION OF THE INVENTION

In the following, embodiments of the present invention are described with reference to the drawings.

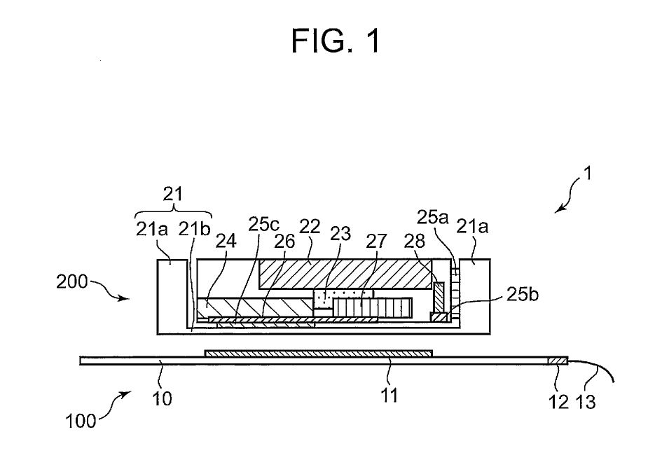

FIG. 1 is a block diagram of an overall configuration of a contactless charging system in accordance with embodiments of the present invention viewed from a side thereof.

A contactless charging system 1 includes a charger 100 as a charging device and an electronic device 200 to be charged thereby.

The charger 100 is in the shape of a sheet, and can be folded.

On the front face of the charger 100, an electricity transmission wire 11 is disposed in a way described below. Both ends of the electricity transmission wire 11 are connected to a power cord 13, which is connected to an external power source, via a power circuit 12, which is disposed on an end of the electricity transmission wire 11. As the external power source, a normal commercial power source can be used.

That is, an AC voltage of 50 Hz or 60 Hz is supplied to the power circuit 12.

The power circuit 12 supplies power with a frequency which is the same as the frequency supplied to the power circuit 12 to the electricity transmission wire 11, converting the voltage or limiting the current as needed.

As a voltage conversion circuit of the power circuit 12, various well-known circuits can be used, and hence description thereof is omitted.

The electronic device 200 is an electronic watch, for example. The electronic watch includes, in a case (electrically conductive case) 21, a display operation unit 22, a motor 23, a receiving circuit 24, magnetic sheets (magnetic substances) 25a, 25b and 25c, an electricity reception coil 26 and a power source unit 27 as an electricity accumulation unit.

The display operation unit 22 is, for example, a train wheel mechanism in which gear wheels for hands to display time are disposed.

The gear wheels of the train wheel mechanism are driven by the motor 23 to rotate. The receiving circuit 24 is, for example, a receiving circuit used to obtain time information by receiving a standard radio wave.

The magnetic sheets 25a and 25b are disposed to reduce an eddy current generated in the case 21 by being magnetically influenced by an antenna 28, which is used to receive the standard radio wave.

The electricity reception coil 26 is paired with the electricity transmission wire 11 of the charger 100, and used to receive power.

The electricity reception coil 26 is disposed near a back cover 21b of the case 21 in such a way as to be parallel with the back cover 21b.

Disposition, and configuration of the electricity reception coil 26 are described below in detail.

The magnetic sheet 25c is disposed over the electricity reception coil 26 in such a way as to cover the electricity reception coil 26 so as to return magnetic flux, which enters the electronic device 200 from the charger 100, to a side (charger 100 side), where the charger 100 is disposed, within the area of the magnetic sheet 25c.

The power source unit 27 includes a secondary battery which can be charged, accumulate electricity, and discharge electricity and a charging circuit to charge the secondary battery on the basis of electromotive force generated in the electricity reception coil 26.

The charging circuit includes a rectifier circuit, which rectifies an AC voltage, and a voltage limiter, which limits a (AC) voltage when a large voltage is applied.

The case 21 is made of electrically conductive metal. For example, stainless steel such as SUS304 is used.

The case 21 is formed in such a way that the back cover 21b is thinner than a ring-shaped frame 21a as a lateral face of the case 21.

The thickness of the back cover 21b is about 1 mm, for example.

The thickness of the back cover 21b is sufficiently thinner than depth of penetration corresponding to change of magnetic flux generated when an AC voltage of 50 Hz or 60 Hz is applied to the electricity transmission wire 11. The depth of penetration relates to loss caused by the eddy current generated in the back cover 21b.

Accordingly, the loss can be reduced.

Electronic watches often require low power for their operation. Hence, keeping power supplied thereto at the time of charging low is a way to reduce a heating value.

Next, shapes of the electricity transmission wire 11 and the electricity reception coil 26 and disposition thereof are described.

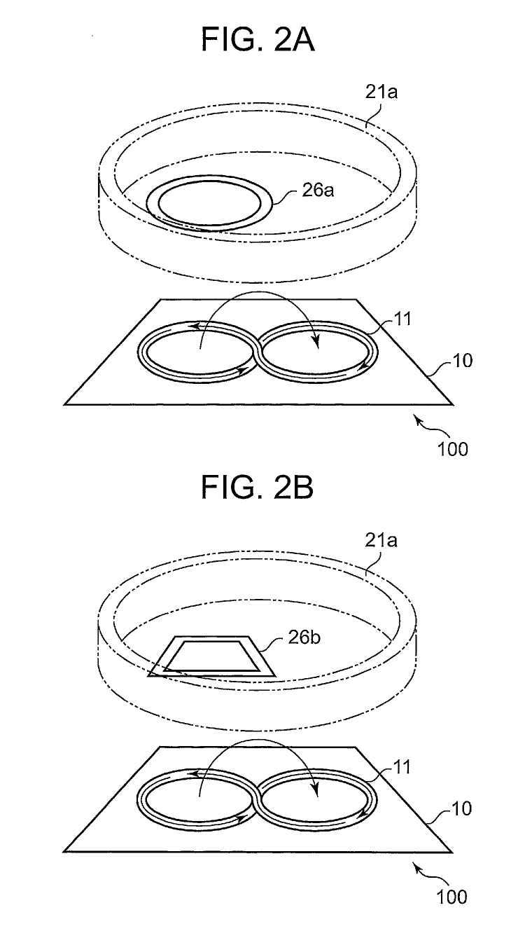

FIGS. 2A and 2B each show a shape and a position of the electricity transmission wire 11 of the charger 100 and the shape and the position of the electricity reception coil 26 of the electronic device 200 as an example.

In FIGS. 2A and 2B, in addition to the electricity transmission wire 11 and the electricity reception coil 26, a position of the frame 21a with respect to a position of the electricity reception coil 26 is shown. The other components (units and the like) are not shown therein.

### First Embodiment

FIG. 2A shows a disposed shape (pattern) of the electricity transmission wire 11 and a position of an electricity reception coil 26a in the contactless charging system 1 in accordance with a first embodiment of the present invention.

The electricity transmission wire 11 is disposed in such a way that two circular (ring-shaped) regions (a first loop structure and a second loop structure) are connected to each other at the center of the upper face of a sheet 10.

These two circular regions are connected to each other in such a way that when a predetermined voltage to generate a voltage difference is applied to the both ends of the electricity transmission wire 11, the ends being connected to the power circuit 12, a current flows through the two circular regions in opposite directions to each other.

That is the electricity transmission wire 11 is disposed in the shape of “8” (a figure eight).

By this disposed shape, when a voltage is applied to the electricity transmission wire 11, directions of the magnetic flax penetrating the two circular regions are always opposite to each other.

The electricity transmission wire 11 may be disposed by going through the same positions multiple times so that parts (patterns) of the wire 11 are piled on top of each other.

Alternatively, a plurality of the disposed shapes (patterns), each of which is smaller than the above-described disposed shape, may be disposed in parallel.

It is preferable that the total size of the two circular regions formed by the electricity transmission wire 11 be smaller than the size (diameter) of the frame 21a.

Furthermore, it is preferable that the two circular regions be formed to be the same in the shape and/or the area as much as possible.

By the electricity transmission wire 11 disposed in the above-described pattern, most of the magnetic flux (lines of magnetic force) penetrating, in the up direction, the circular region formed on the left side on the sheet 10 shown in FIG. 2A returns the sheet 10 as the magnetic flux (lines of magnetic force) penetrating, in the down direction, the circular region formed on the right side on the sheet 10.

That is, most of the magnetic flux outputted from the charger 100 returns to the charger 100 without leaking to the outside of the frame 21a.

Furthermore, the direction of the magnetic flux on the left half of the sheet 10 shown in FIG. 2A and the direction of the magnetic flux on the right half of the sheet 10 are opposite to each other. Consequently, the magnetic flux loops within the frame 21a, and accordingly the magnetic flux going around a part of the frame 21a decreases.

If the AC magnetic flux which penetrates the back cover 21b goes round a part of the frame 21a, the electromotive force is generated in the frame 21a by electromagnetic induction.

The frame 21a is made of an electrically conductive material and thick. Hence, electrical resistance thereof is very low.

Consequently, when a voltage is applied to the frame 21a, a large current easily flows, and the frame 21a cancels change of the magnetic flux penetrating the back cover 21b as a short circuit ring.

The disposed shape of the electricity transmission wire 11 of the first embodiment prevents the electric loss to be caused by the frame 21a.

The circular regions of the electricity transmission wire 11 are not necessary to be completely round, and hence may be oval or polygonal (for example, square, rectangular or rhombic).

Alternatively, the electricity transmission wire 11 may be disposed in the shape of “S” so as not to be disposed within a predetermined range of angles in an angular direction of each of the circular regions.

The electricity reception coil 26a is formed by winding a wire multiple times, as is the case with a normal coil. Both ends of the electricity reception coil 26a are connected to the charging circuit.

The electricity reception coil 26a of the first embodiment is the same as at least one of the two circular regions of the electricity transmission wire 11 in size and shape.

The electricity reception coil 26a of the first embodiment is disposed in such a way as to be superposed on one of the circular regions of the electricity transmission wire 11 when the center of the sheet 10 and the center of the frame 21a coincide.

By displaying a relative positional relationship of the charger 100 and the electronic device 200 on the sheet 10, the electronic device 200 can be disposed on the charger 100 with a proper positional relationship at the time of charging.

In the case where the two circular regions are the same in shape and size as described above, no matter on which one of the two circular regions the electricity reception coil 26a is superposed, charging can be properly performed.

If the electricity reception coil 26a is disposed in such a way as to overlap both of the two circular regions, which are formed by the electricity transmission wire 11, or to overlap both the inside and the outside of one of the circular regions, the magnetic flux penetrating the electricity reception coil 26a in the up direction and the magnetic flux penetrating the electricity reception coil 26a in the down direction cancel each other out, whereby the total amount thereof is 0.

Consequently, it is preferable that the electronic device 200 be disposed on the sheet 10 of the charger 100 in such a way that a difference in size between a region of an upward magnetic field and a region of a downward magnetic field in the down direction, the regions being included in the electricity reception coil 26a, is large. However, as long as the electricity reception coil 26a is not disposed in such a way as to overlap both of the two circular regions equally, the secondary battery is charged with efficiency in accordance with the position where the electricity reception coil 26a is disposed.

Thus, the electricity reception coil 26a is formed in the size and the shape with which the change of the magnetic flux penetrating the electricity reception coil 26a becomes large as much as possible in accordance with the change of the voltage applied to the electricity transmission wire 11, and can be disposed at the best position with respect to the electricity transmission wire 11.

FIG. 2B shows an electricity reception coil in accordance with a modification, the electricity reception coil being included in the electronic device 200 of the first embodiment.

An electricity reception coil 26b has the shape of a square frame, unlike the electricity reception coil 26a which has the shape of a circular ring.

That is, the shape of the electricity reception coil 26 is not limited to the shape of one of the regions, which are circular, formed by the electricity transmission wire 11.

For example, if, because of the components disposed in the small electronic device 200, the electricity reception coil 26b having the same shape and the same size as those of one of the regions of the electricity transmission wire 11 cannot be disposed therein, the electricity reception coil 26b having another shape (and/or another size) suitable to be disposed therein can be disposed therein.

If the electricity reception coil 26b has the shape to overlap both of the two circular regions, which are formed by the electricity transmission wire 11, or to overlap both the inside and the outside of one of the circular regions, the magnetic flux penetrating the electricity reception coil 26b in the up direction and the magnetic flux penetrating the electricity reception coil 26h in the down direction cancel each other out, whereby the total amount thereof is 0.

Consequently, it is preferable that a difference in size between a region of an upward magnetic field and a regio of a downward magnetic field, the regions being included in the electricity reception coil 26b, is large.

If the electricity reception coil 26b has the size and the shape to be contained in one of the circular regions of the electricity transmission wire 11, influence on charging efficiency related to the shape of the electricity reception coil 26b can be small, and hence the secondary battery of the power source unit 27 can be properly charged.

Thus, the contactless charging system 1 of the first embodiment includes the charger 100 and the electronic device 200. The charger 100 is provided with the two circular regions, which are formed by the electricity transmission wire 11 and generate the magnetic flux having polarities opposite to each other. The electronic device 200 includes the electricity reception coil 26 contained in the metal case 21. The electricity reception coil 26 obtains power by electromagnetic induction by the magnetic flux outputted from the charger 100.

According to the contactless charging system 1 having the configuration, if the magnetic flux outputted from the charger 100 is changed by the AC voltage applied to the electricity transmission wire 11, the magnetic flux leaking from the inside of the frame 21a can be reduced. Consequently, the frame 21a of the electronic device 200 does not function as a short circuit ring, and hence the secondary battery of the electronic device 200 can be efficiently changed.

Accordingly, as a material of the case 21 of the electronic device 200, the frame 21a in particular, not only a material having low electrical conductivity but also electrically conductive metal can be used, and hence the range of choices for the material can be expanded.

Furthermore, by disposing the magnetic sheet 25c over the electricity reception coil 26, the magnetic flux entering the electronic device 200 from the charger 100 can be returned to the charger 100 side within the area of the magnetic sheet 25c, namely, within the frame 21a. Hence, the electronic device 200 can be efficiently charged.

Furthermore, the electricity reception coil 26 is disposed for, among the lines of magnetic force (magnetic flux) going into and out of the charger 100, the magnetic flux in one direction mainly. Accordingly, the electronic device 200 can be efficiently charged.

Furthermore, by forming the circular regions, which are formed by the electricity transmission wire 11, in the shape of a figure eight, the charger 100 can be easily manufactured.

Furthermore, by disposing the circular regions, which are formed by the electricity transmission wire 11, within the area of the frame 21a, more of the lines of magnetic force, which loop, can be kept within the frame 21a. Accordingly, the effect of the frame 21a as a short circuit ring can be reduced for sure.

Furthermore, the magnetic flux almost vertically penetrates the back cover 21b and the electricity reception coil 26 from the charger 100. In addition, the rate of the change of the magnetic flux is a low frequency, which is around a frequency of a commercial power source, and the thickness of the back cover 21b is set to be thinner than the depth of penetration corresponding to the frequency. Accordingly, in addition to the reduction of loss caused by the frame 21a, heat generation and loss caused by the back cover 21b can be reduced.

### Second Embodiment

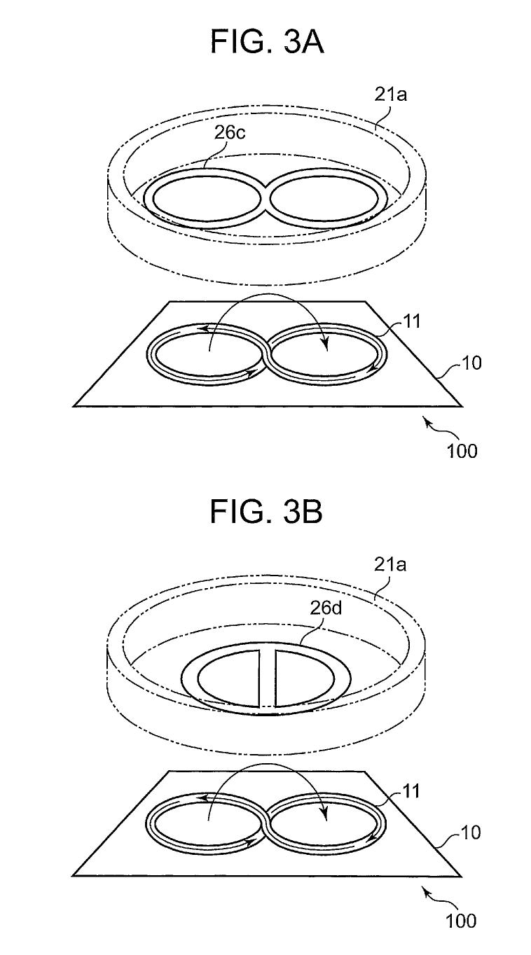

FIG. 3A shows a shape of an electricity reception coil included in the electronic device 200 in the contactless charging system 1 in accordance with a second embodiment of the present invention.

Difference between the contactless charging systems 1 of the first embodiment and the second embodiment is only the shape and disposition of an electricity reception coil. The other components in the second embodiment are denoted by the reference numbers, which are the same as those in the first embodiment, and hence description thereof is omitted.

An electricity reception coil 26c of the contactless charging system 1 of the second embodiment is formed in the shape of a figure eight, which is the same as that formed by the electricity transmission wire 11. The change of the magnetic flux in directions opposite to each other is given to the two circular regions formed in the electricity reception coil 26c, so that double electromotive force is generated in the electricity reception coil 26c in one direction.

At the time of charging, the electronic device 200 is disposed on the charger 100 in such a way that the two circular regions of the electricity reception coil 26c are superposed on the two closed regions (a first coil part and a second coil part) of the electricity transmission wire 11, respectively.

Accordingly, the change of the magnetic flux outputted from the charger 100 can be efficiently converted into the electromotive force in the electricity reception coil 26c of the electronic device 200.

Furthermore, as is the case with the first embodiment, the magnetic flux within the frame 21a is almost fixed (uniform) regardless of the change of the voltage applied to the electricity transmission wire 11 of the charger 100. Accordingly, as is the case with the first embodiment, the loss caused by the frame 21a can be reduced.

FIG. 3B shows an electricity reception coil in accordance with a modification, the electricity reception coil being included in the contactless charging system 1 of the second embodiment.

In an electricity reception coil 26d of the modification, like the electricity reception coil 26c described above, two closed regions are formed.

The electricity reception coil 26d is in the shape of “θ” so as to be symmetrical about the center of the metal frame 21a.

That is, the shapes of the two closed regions of the electricity reception coil 26d are not limited to the shapes of the two circular regions of the electricity transmission wire 11.

In the modification, the two closed regions of the electricity reception coil 26d are disposed in such a way that neither of the two closed regions overlaps both of the two circular regions of the electricity transmission wire 11.

The two closed regions of the electricity reception coil 26d include regions not to overlap either of the two circular regions of the electricity transmission wire 11.

Both sides of a connecting part of the two circular regions are the regions where magnetic fields generated by the current flowing through the electricity transmission wire 11, which forms the two circular regions, are cancelled. Accordingly, a bad influence, such as the electromotive force based on the change of the magnetic flux within the circular regions being cancelled, is not casted on the contactless charging system 1.

Accordingly, the electromotive force based on the change of the magnetic flux within the areas where the closed regions are superposed on the circular regions, respectively, is generated, and the secondary battery of the power source unit 27 is changed.

As the shape to provide two closed regions, the shape of “S” or the like may be used instead of the shape of “8” (a figure eight) or the shape of “θ” which are described above.

The respective shapes of the two closed regions may be oval or polygon (for example, square, rectangular or rhombic).

The two closed regions do not need to contact each other. In any case, it, is preferable that the closed regions are disposed in such a way that neither of the closed regions overlaps both of the two circular regions of the electricity transmission wire 11.

Thus, the contactless charging system 1 of the second embodiment includes the charger 100 and the electronic device 200. The charger 100 is provided with the two circular regions, which are formed by the electricity transmission wire 11 and generate the magnetic flux having polarities opposite to each other. The electronic device 200 can be charged by generating the electromotive force with the two closed regions provided for the two circular regions, respectively. Consequently, the frame 21a of the electronic device 200 does not function as a short circuit ring, and hence the secondary battery of the electronic device 200 can be efficiently changed.

### Third Embodiment

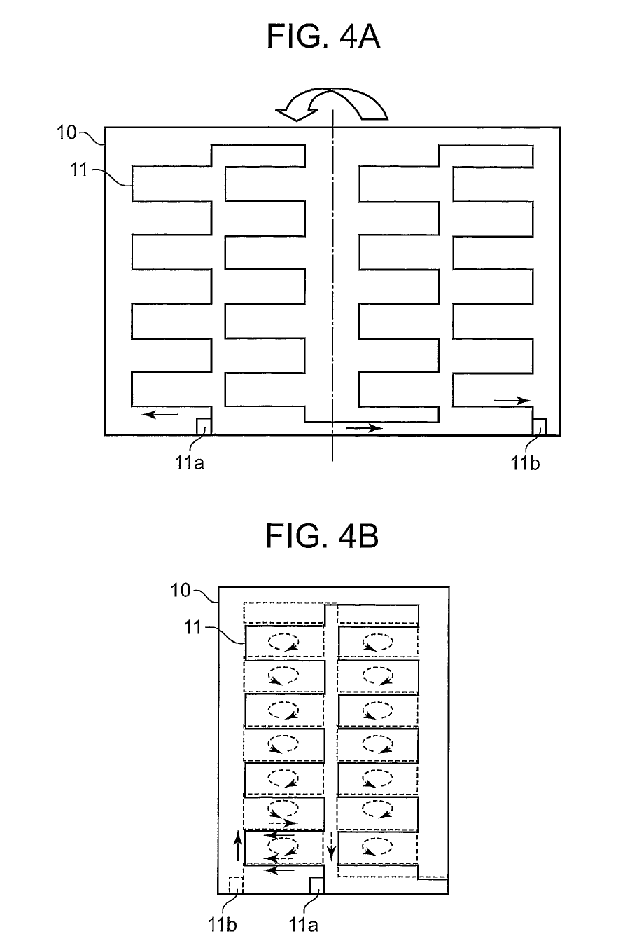

FIGS. 4A and 4B each show the charger 100 of the contactless charging system 1 in accordance with a third embodiment of the present invention.

Difference between the contactless charging systems 1 of the first embodiment and the third embodiment is only patterns to dispose the electricity transmission wire 11 on the sheet 10 of the charger 100. The other aspects are the same as those in the first embodiment, and hence description thereof is omitted.

The charger 100 of the third embodiment is in the shape of a sheet as described above. The sheet 10 on which the electricity transmission wire 11 is disposed is folded so that parts (patterns) of the electricity transmission wire 11 are piled on top of each other.

In the electricity transmission wire 11, a plurality of small circular regions is disposed in a lattice.

As shown in FIG. 4A, an electrode 11a, which is one end of the electricity transmission wire 11 and connected to the power circuit 12, is disposed on the left half of the sheet 10. The electricity transmission wire 11 is led from the left half to the right half of the sheet 10. An electrode 11b, which is the other end of the electricity transmission wire 11 and connected to the power circuit 12, is disposed on the right half of the sheet 10.

By folding the sheet 10 along the middle, as shown in FIG. 4B, the electricity transmission wire 11 (pattern) on the left half of the sheet 10 and the electricity transmission wire 11 (pattern) on the right half of the sheet 10, the patterns being the same, are superposed on top of each other. Accordingly, the electricity transmission wire 11 functions the same as a laminated coil.

Similarly, by folding the sheet 10 multiple times, the charger 100 including the electricity transmission wire 11 disposed to be a coil style can be configured.

In this case, directions of the magnetic flux generated by penetrating the circular regions next to each other are opposite.

Accordingly, when the electronic device 200 is charged, most of the magnetic flux (lines of magnetic force) of a first circular region disposed inside the frames 21a goes in and out of a second circular region next to the first circular region, and does not leak to the outside of the frame 21a. On the other hand, some of the magnetic flux of a circular region (or circular regions) disposed in the vicinity of the frame 21a or in an area to overlap both the inside and the outside of the frame 21a goes around a part of the frame 21a. Consequently, the change of the magnetic flux generates the electromotive force in a part of the frame 21a.

However, as a whole, much electromotive force is not generated.

As described above, the contactless charging system 1 of the third embodiment includes the charger 100 and the electronic device 200. In the charger 100, a plurality of coil-style circular regions disposed in two dimensions is formed by the electricity transmission wire 11 disposed on the sheet 10, and the circular regions are disposed in such a way that the directions of the magnetic flux generated in the circular regions next to each other are opposite to each other. The electronic device 200 is provided with the electricity reception coil 26 smaller than the frame 21.a. Accordingly, if the electronic device 200 is properly disposed on the sheet 10, as is the case with the other embodiments, the frame 21a is prevented, from forming a short circuit ring.

Furthermore, the contactless charging system 1 of the third embodiment does not require accurate positioning to dispose the electronic device 200 on the sheet 10 at the time of charging. Without that, the secondary battery of the electronic device 200 can be efficiently charged.

Furthermore, because the sheet-shaped charger 100 is used by being appropriately folded, the charger 100 can be easily manufactured and make it function only by providing patterns to dispose the electricity transmission wire 11 on the sheet 10.

The present invention is not limited to the embodiments described above, and hence can be variously modified.

For example, in the embodiments, the sheet-shaped charger 100 is described as an example of the charging device. However, the charger 100 may be thicker or may be in the shape of a stand so that the electronic device 100 can be set against the charger 100.

Furthermore, in the embodiments, the electronic watch is described as an example of the electronic device. However, this is not a limitation.

For example, the electronic device may be other types of electronic timepieces, such as a pocket watch or a clock, or may be electronic devices other than electronic timepieces, such as a mobile phone or a portable audio player.

Furthermore, in the charger 100 of the embodiments, the AC voltage applied to the two ends of the electricity transmission wire 11 is applied to a plurality of circular regions which are disposed in series. However, the AC voltage may be applied to a plurality of circular regions which are disposed in parallel.

Furthermore, the specific configuration and disposition described in the embodiments can be appropriately modified without departing from the scope and spirit of the present invention.

Several embodiments of the present invention are described, above. However, the scope of the present invention is not limited to the embodiments, and includes the scope of the appended claims and their equivalents.

What is claimed is:

1. A contactless charging system comprising:
an electronic device including:
a case including a ring-shaped frame;
an electricity reception coil disposed in the case; and
an electricity accumulation unit connected to the electricity reception coil; and
a charging device including:
an electricity transmission wire disposed within a predetermined plane in a predetermined pattern by which directions of magnetic fields respectively generated in a first region and a second region into which an area where the frame is disposed is divided are opposite to each other, wherein
the charging device applies an alternating current voltage having a predetermined frequency to the electricity transmission wire so as to generate the magnetic fields which change at the frequency, and charges the electricity accumulation unit of the electronic device disposed on the plane of the charging device by electromagnetic induction between the electricity reception coil and the electricity transmission wire.

2. The contactless charging system according to claim 1, wherein the case is constituted of an electrically conductive material.

3. The contactless charging system according to claim 1, wherein a magnetic substance is disposed over the electricity reception coil.

4. The contactless charging system according to claim 1, wherein
the pattern includes two or more patterns, and
the electricity transmission wire is disposed in such a way that the patterns are disposed in two dimensions within the plane.

5. The contactless charging system according to claim 1, wherein
the pattern includes two or more patterns, and
the electricity transmission wire is disposed within a sheet as the plane, and the sheet is folded so that the patterns are laid on top of each other.

6. The contactless charging system according to claim 1, wherein
the electricity reception coil includes at least a first coil part, and
the first coil part is connected to the electricity accumulation unit in a direction in which first electromotive force having a polarity is obtained from one of the first region and the second region.

7. The contactless charging system according to claim 6, wherein
the pattern includes a first loop structure in the one of the first region and the second region and a second loop structure in the other of the first region and the second region, and
the electricity transmission coil includes the first coil part which obtains the first electromotive force from the first loop structure and a second coil part which obtains second electromotive force having a polarity identical to the polarity of the first electromotive force from the second loop structure.

8. The contactless charging system according to claim 6, wherein
the pattern includes a first loop structure in the one of the first region and the second region and a second loop structure in the other of the first region and the second region, and
the first coil part obtains the first electromotive force on the basis of magnetic flux penetrating one of the first loop structure and the second loop structure.

9. The contactless charging system according to claim 7, wherein the first loop structure and the second loop structure are connected to each other on a borderline of the first region and the second region so as to make a figure eight.

10. The contactless charging system according to claim 7, wherein the first loop structure and the second loop structure are disposed within the area where the frame is disposed.

11. The contactless charging system according to claim 1, wherein
the case includes a back cover which covers a lower part of the case,
the frequency is a commercial power frequency, and
thickness of the back cover is thinner than depth of penetration determined by a material of the back cover and the commercial power frequency.

12. A charging device which charges an electronic device in a contactless manner, the electronic device including a case including a ring-shaped frame, an electricity reception coil disposed in the case and an electricity accumulation unit connected to the electricity reception coil, the charging device comprising:
an electricity transmission wire disposed within a predetermined plane in a predetermined pattern by which directions of magnetic fields respectively generated in a first region and a second region into which an area where the frame is disposed is divided are opposite to each other, wherein
the charging device applies an alternating current voltage having a predetermined frequency to the electricity transmission wire so as to generate the magnetic fields which change at the frequency, and charges the electricity accumulation unit of the electronic device disposed on the plane of the charging device by electromagnetic induction between the electricity reception coil and the electricity transmission wire.
